(19) United States
(12) Patent Application Publication
(10) Pub. No.: US 2023/0367548 A1
(43) Pub. Date: Nov. 16, 2023

(54) COMPUTING METHOD

(71) Applicant: KUNLUNXIN TECHNOLOGY (BEIJING) COMPANY LIMITED, BEIJING (CN)

(72) Inventors: Peng WU, BEIJING (CN); Jian OUYANG, BEIJING (CN)

(73) Assignee: KUNLUNXIN TECHNOLOGY (BEIJING) COMPANY LIMITED, BEIJING (CN)

(21) Appl. No.: 18/320,524

(22) Filed: May 19, 2023

(30) Foreign Application Priority Data
May 20, 2022 (CN) 202210553451.2

(51) Int. Cl. G06F 7/483; G06F 17/16

(52) U.S. Cl. CPC G06F 7/483; G06F 17/16

(57) ABSTRACT

A computing method is provided. The computing method includes: obtaining a plurality of first fixed point numbers and a plurality of first exponents that correspond to the plurality of first floating point numbers, and a plurality of second fixed point numbers and a plurality of second exponents that correspond to the plurality of second floating point numbers; obtaining a fixed point product of each of the plurality of first fixed point numbers and a second fixed point number corresponding to the first fixed point number, and a corresponding fixed point product exponent; obtaining a fixed point inner product calculation result of the first vector and the second vector; and obtaining, based on the fixed point inner product calculation result, a floating point inner product calculation result in a floating point data format corresponding to the fixed point inner product calculation result.

### CROSS REFERENCE TO RELATED APPLICATION

This application claims priority to Chinese patent application No, 202210553451.2 filed on May 20, 2022, the contents of which are hereby incorporated by reference in their entirety for all purposes.

### TECHNICAL FIELD

The present disclosure relates to the technical field of computers, and in particular, to the technical field of chips and artificial intelligence, and specifically, to a computing method and apparatus, a chip, an electronic device, and a computer-readable storage medium.

### BACKGROUND ART

With the development of artificial intelligence technologies, more and more applications have achieved much better effects than traditional algorithms based on artificial intelligence technologies. Deep learning is the core technology of artificial intelligence technologies at its present. Deep learning is a data intensive algorithm and a computation intensive algorithm, and is also an algorithm that develops quickly in an iterative manner.

Traditional general-purpose processing devices such as a CPU, a GPU, and a DSP are designed for general computing tasks and have shortcomings such as low computing performance and low efficiency when processing deep learning applications, and cannot effectively support large-scale deployment of deep learning algorithms in scenarios such as data centers. An ASIC/FPGA-based deep learning dedicated acceleration device has a hardware structure deeply customized according to the computing feature of deep learning, and therefore can achieve higher computing performance and computing efficiency compared with traditional devices such as a CPU, a GPU, and a DSP.

The methods described in this section are not necessarily methods that have been previously conceived or employed. It should not be assumed that any of the methods described in this section is considered to be the prior art just because they are included in this section, unless otherwise indicated expressly. Similarly, the problem mentioned in this section should not be considered to be universally recognized in any prior art, unless otherwise indicated expressly.

### SUMMARY OF THE INVENTION

The present disclosure provides a computing method and apparatus, a chip, an electronic device, a computer-readable storage medium, and a computer program product.

According to an aspect of the present disclosure, a computing method executed by a computing apparatus is provided, including: obtaining, based on a plurality of first floating point numbers of a first vector and a plurality of second floating point numbers of a second vector that are input to the computing apparatus, a plurality of first fixed point numbers in binary representation and a plurality of first exponents in binary representation that correspond to the plurality of first floating point numbers respectively, and a plurality of second fixed point numbers in binary representation and a plurality of second exponents in binary representation that correspond to the plurality of second floating point numbers respectively, wherein the plurality of first floating point numbers correspond to the plurality of second floating point numbers, and each of the plurality of first fixed point number and the plurality of second fixed point numbers comprises a sign bit and a first preset number of fixed point mantissa bits; obtaining a fixed point product and a fixed point product exponent corresponding to the fixed point product of each first fixed point number of the plurality of first fixed point numbers and a second fixed point number corresponding to the first fixed point number; obtaining a fixed point inner product calculation result of the first vector and the second vector based on the fixed point product exponent corresponding to each of a plurality of fixed point products corresponding to the plurality of first fixed point numbers; and obtaining; based on the fixed point inner product calculation result, a floating point inner product calculation result in a floating point data format corresponding to the fixed point inner product calculation result.

According to another aspect of the present disclosure, a computing method executed by a computing apparatus is provided, including: obtaining a first matrix and a second matrix, where the first matrix includes a first number of row vectors, the second matrix includes a second number of column vectors, and the row vector and the column vector have a same length; and obtaining an inner product result of each row vector in the first matrix and each column vector in the second matrix according to the above computing method executed by the computing apparatus to calculate an inner product of vectors, to obtain an inner product result matrix of the first matrix and the second matrix.

According to another aspect of the present disclosure, a computing apparatus is provided, including: a first obtaining unit configured to: based on a plurality of first floating point numbers of a first vector and a plurality of second floating point numbers of a second vector that are input to a computing apparatus, obtain a plurality of first fixed point numbers in binary representation and a plurality of first exponents that correspond to the plurality of first floating point numbers, and a plurality of second fixed point numbers in binary representation and a plurality of second exponents that correspond to the plurality of second floating point numbers, where the plurality of first floating point numbers and the plurality of second floating point numbers are in a one-to-one correspondence, and each of the plurality of first fixed point number and the plurality of second fixed point numbers includes a sign bit and a first preset number of fixed point mantissa bits; a multiplier configured to obtain a fixed point product of each of the plurality of first fixed point numbers and a second fixed point number corresponding to the first fixed point number, and a corresponding fixed point product exponent; a second obtaining unit configured to obtain a fixed point inner product calculation result of the first vector and the second vector based on a fixed point product exponent corresponding to each of a plurality of fixed point products corresponding to the plurality of first fixed point numbers; and a third obtaining unit configured to obtain, based on the fixed point inner product calculation result, a floating point inner product calculation result in a floating point data format corresponding to the fixed point inner product calculation result.

According to another aspect of the present disclosure, a computing apparatus is provided, including: a fourth obtaining unit configured to obtain a first matrix and a second matrix, where the first matrix includes a first number of row vectors, the second matrix includes a second number of column vectors, and the row vector and the column vector have a same length; and a fifth obtaining unit configured to obtain an inner product result of each row vector in the first matrix and each column vector in the second matrix according to the above computing method executed by the computing apparatus to calculate an inner product of vectors, to obtain an inner product result matrix of the first matrix and the second matrix.

According to another aspect of the present disclosure, a chip is provided, including at least one of the following apparatuses: the above computing apparatus for calculating an inner product of vectors and the above computing apparatus for calculating an inner product of matrices.

According to another aspect of the present disclosure, an electronic device is provided, including the above chip.

According to another aspect of the present disclosure, an electronic device is provided, including: one or more processors; and a memory storing one or more programs configured to be executed by the one or more processors, the one or more programs comprising instructions for performing operations comprising: obtaining, based on a plurality of first floating point numbers of a first vector and a plurality of second floating point numbers of a second vector that are input to the electronic device, a plurality of first fixed point numbers in binary representation and a plurality of first exponents in binary representation that correspond to the plurality of first floating point numbers respectively, and a plurality of second fixed point numbers in binary representation and a plurality of second exponents in binary representation that correspond to the plurality of second floating point numbers respectively, wherein the plurality of first floating point numbers correspond to the plurality of second floating point numbers, and each of the plurality of first fixed point number and the plurality of second fixed point numbers comprises a sign bit and a first preset number of fixed point mantissa bits; obtaining a fixed point product and a fixed point product exponent corresponding to the fixed point product of each first fixed point number of the plurality of first fixed point numbers and a second fixed point number corresponding to the first fixed point number; obtaining a fixed point inner product calculation result of the first vector and the second vector based on the fixed point product exponent corresponding to each of a plurality of fixed point products corresponding to the plurality of first fixed point numbers; and obtaining, based on the fixed point inner product calculation result, a floating point inner product calculation result in a floating point data format corresponding to the fixed point inner product calculation result.

According to another aspect of the present disclosure, a non-transitory computer-readable storage medium is provided. The non-transitory computer-readable storage medium stores one or more programs comprising instructions that, when executed by one or more processors of a computing device, cause the computing device to perform operations comprising: obtaining, based on a plurality of first floating point numbers of a first vector and a plurality of second floating point numbers of a second vector that are input to the computing device, a plurality of first fixed point numbers in binary representation and a plurality of first exponents in binary representation that correspond to the plurality of first floating point numbers respectively, and a plurality of second fixed point numbers in binary representation and a plurality of second exponents in binary representation that correspond to the plurality of second floating point numbers respectively, wherein the plurality of first floating point numbers correspond to the plurality of second floating point numbers, and each of the plurality of first fixed point number and the plurality of second fixed point numbers comprises a sign bit and a first preset number of fixed point mantissa bits; obtaining a fixed point product and a fixed point product exponent corresponding to the fixed point product of each first fixed point number of the plurality of first fixed point numbers and a second fixed point number corresponding to the first fixed point number; obtaining a fixed point inner product calculation result of the first vector and the second vector based on the fixed point product exponent corresponding to each of a plurality of fixed point products corresponding to the plurality of first fixed point numbers; and obtaining, based on the fixed point inner product calculation result, a floating point inner product calculation result in a floating point data format corresponding to the fixed point inner product calculation result.

It should be understood that the content described in this section is not intended to identify critical or important features of the embodiments of the present disclosure, and is not used to limit the scope of the present disclosure. Other features of the present disclosure will be easily understood through the following specification.

### BRIEF DESCRIPTION OF THE DRAWINGS

The accompanying drawings exemplarily show embodiments and form a part of the specification, and are used to explain example implementations of the embodiments together with a written description of the specification. The embodiments shown are merely for illustrative purposes and do not limit the scope of the claims. Throughout the accompanying drawings, the same reference numerals denote similar but not necessarily same elements,

FIG. 1 is a flowchart of a computing method executed by an computing apparatus according to an embodiment of the present disclosure;

FIG. 2 is a structural block diagram of a vector multiplication apparatus according to an embodiment of the present disclosure;

FIG. 3 is a flowchart of obtaining a plurality of first fixed point numbers, a plurality of first exponents, a plurality of second fixed point numbers, and a plurality of second exponents according to an embodiment of the present disclosure;

FIG. 4 is a flowchart of obtaining fixed point products corresponding to a plurality of first fixed point numbers and corresponding fixed point product exponents according to an embodiment of the present disclosure;

FIG. 5 is a structural block diagram of a vector multiplication apparatus according to another embodiment of the present disclosure;

FIG. 6 is a flowchart of a computing method executed by an computing apparatus to calculate a product of matrices according to an embodiment of the present disclosure;

FIG. 7 is a structural block diagram of a matrix multiplication apparatus according to an embodiment of the present disclosure;

FIG. 8 is a structural block diagram of a computing apparatus for calculating an inner product of vectors according to an embodiment of the present disclosure;

FIG. 9 is a structural block diagram of a computing apparatus for calculating a product of matrices according to an embodiment of the present disclosure; and

FIG. 10 is a structural block diagram of an example electronic device that may be configured to implement an embodiment of the present disclosure.

### DETAILED DESCRIPTION OF EMBODIMENTS

Example embodiments of the present disclosure are described below in conjunction with the accompanying drawings, where various details of the embodiments of the present disclosure are included to facilitate understanding, and should only be considered as example. Therefore, those of ordinary skill in the art should be aware that various changes and modifications can be made to the embodiments described herein, without departing from the scope of the present disclosure. Likewise, for clarity and conciseness, the description of well-known functions and structures is omitted in the following description.

In the present disclosure, unless otherwise stated, the terms “first”, “second”, etc., used to describe various elements are not intended to limit the positional, temporal or importance relationship of these elements, but rather only to distinguish one element from the other. In some examples, a first element and a second element may refer to the same instance of the element, and in some cases, based on contextual descriptions, the first element and the second element may also refer to different instances.

The terms used in the description of the various examples in the present disclosure are merely for the purpose of describing particular examples, and are not intended to be limiting. If the number of elements is not specifically defined, there may be one or more elements, unless otherwise expressly indicated in the context. Moreover, the term “and/or” used in the present disclosure encompasses any of and all possible combinations of listed items.

The embodiments of the present disclosure will be described below in detail with reference to the accompanying drawings.

A core operation of a deep learning algorithm is a matrix multiplication operation. A mainstream language model (for example, BERT or ERNIE) includes a large number of matrix multiplication operations. A mainstream machine vision model (a network such as RESNET, MASK-RCNN, YOLO, or SSD) includes a large number of convolution operations that are usually converted into matrix operations for implementation.

In a deep learning network, matrix multiplication operations are all performed based on data in a single precision floating point format (that is, a float format). With the development of deep learning, a relevant technical person finds that for a matrix multiplication operation and a convolution operation, data of fixed point precision such as signed fixed point data of 16 bits can significantly reduce area and power consumption of hardware implementation, achieve a better performance/power consumption ratio and a better performance/area ratio, and ensure no significant loss of precision.

Generally, a matrix multiplication operation in a deep learning network may be performed by a matrix multiplication apparatus in a deep learning chip. The matrix multiplication apparatus supports a fixed point operation, but a relevant technical person needs to use an independent apparatus to first convert data of floating point precision to fixed point data through fixed point conversion, and then input the fixed point data to the matrix multiplication apparatus for an operation.

The embodiments of the present disclosure provide a computing method executed by a computing apparatus. Floating point data input into the computing apparatus may be converted into fixed point data through operation in the computing apparatus, and then a vector multiplication operation or a matrix multiplication operation is performed based on the fixed point data, so as to perform a perception-free operation of converting floating point data into fixed point data and reduce labor costs and save computing resources.

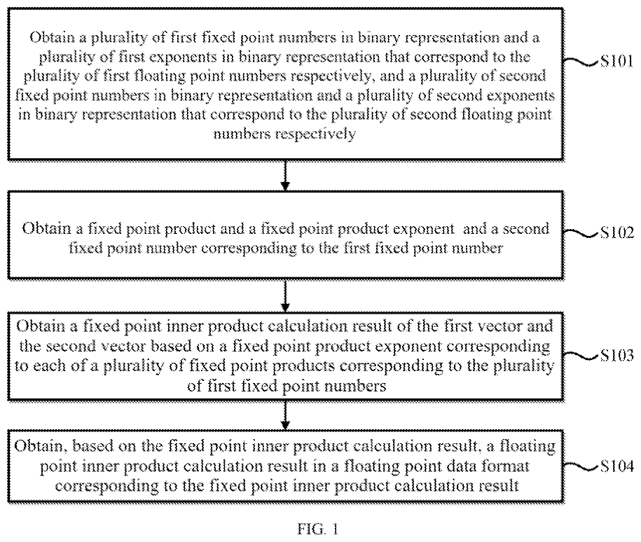

According to an embodiment of the present disclosure, as shown in FIG. 1, a computing method executed by a computing apparatus is provided, including: Step S101: Obtain, based on a plurality of first floating point numbers of a first vector and a plurality of second floating point numbers of a second vector that are input to the computing apparatus, a plurality of first fixed point numbers in binary representation and a plurality of first exponents in binary representation that correspond to the plurality of first floating point numbers respectively, and a plurality of second fixed point numbers in binary representation and a plurality of second exponents in binary representation that correspond to the plurality of second floating point numbers respectively, wherein the plurality of first floating point numbers correspond to the plurality of second floating point numbers, and each of the plurality of first fixed point number and the plurality of second fixed point numbers comprises a sign bit and a first preset number of fixed point mantissa bits. Step S102: Obtain a fixed point product and a fixed point product exponent corresponding to the fixed point product of each first fixed point number of the plurality of first fixed point numbers and a second fixed point number corresponding to the first fixed point number. Step S103: Obtain a fixed point inner product calculation result of the first vector and the second vector based on the fixed point product exponent corresponding to each of a plurality of fixed point products corresponding to the plurality of first fixed point numbers. Step S104: Obtain, based on the fixed point inner product calculation result, a floating point inner product calculation result in a floating point data format corresponding to the fixed point inner product calculation result.

Therefore, floating point data input into the computing apparatus may be converted into fixed point data through operation in the computing apparatus, and a relevant operation is performed based on the fixed point data, so as to perform a perception-free operation of converting floating point data into fixed point data, and reduce labor costs and save computing resources.

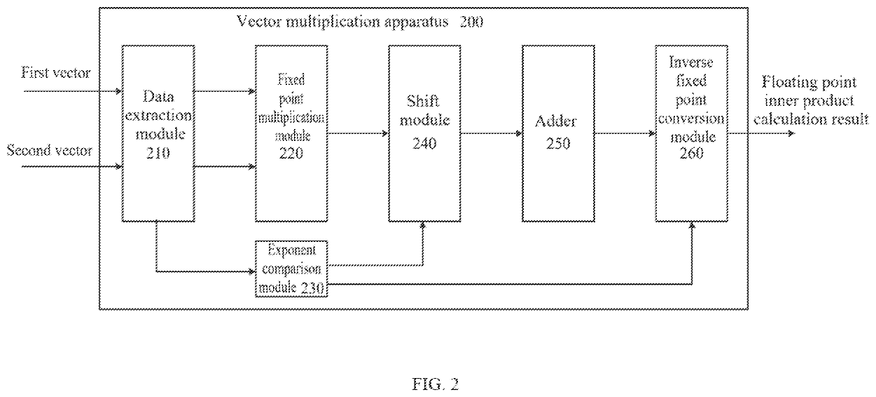

FIG. 2 is a structural block diagram of a vector multiplication apparatus according to an embodiment of the present disclosure.

In some embodiments, a vector multiplication apparatus 200 shown in FIG. 2 may be an computing apparatus arranged on a chip, and the above computing method may be performed by the vector multiplication apparatus 200. Specifically, the vector multiplication apparatus 200 includes a data extraction module 210, a fixed point multiplication module 220, an exponent comparison module 230, a shift module 240, an adder 250, and an inverse fixed point conversion module 260.

According to the IEEE 754 standard, single precision floating point data is expressed as {S, E, M}, including 1 sign bit S 8 exponent bits E, and 23 floating point mantissa bits M. An actual value N of the floating point data may be calculated based on the following formula:

N=(−1)^{S}×1.M×2^{(E-127)}

In some embodiments, a first vector A {a[0], a[1], . . . , a[k−1]} and a second vector B {b[0], b[1], . . . , b[k−1]} are first input into the data extraction module 210 in the vector multiplication apparatus 200 in parallel, where k is a positive integer greater than 2. Each first floating point number a[i] in the first vector A and each second floating point number b[i] in the second vector B are single precision floating point data (where i∈[0, k−1]), and have storage formats as described above.

In some embodiments, the data extraction module 210 may first process each first floating point number a[k−1] and each second floating point number b[k−1], and convert the first floating point number and the second floating point number into a first fixed point number and a second fixed point number.

In some embodiments, as shown in FIG. 3, the obtaining a plurality of first fixed point numbers in binary representation and a plurality of first exponents that correspond to the plurality of first floating point numbers, and a plurality of second fixed point numbers in binary, representation and a plurality of second exponents that correspond to the plurality of second floating point numbers includes: for each floating point number of the plurality of first floating point numbers and the plurality of second floating point numbers, performing the following operations: Step S301: Extract a sign bit, one or more exponent bits, and a plurality of floating point mantissa bits in the floating point number, wherein the floating point number is in binary representation. Step S302: Extract a second preset number of most significant mantissa bits from most significant bits of the plurality of floating point mantissa bits. Step S303: Determine, based on the most significant mantissa bits, a fixed point number corresponding to the floating point number. Step S304: Determine, based on the one or more exponent bits of the floating point number, an exponent corresponding to the floating point number.

Therefore, the computing apparatus of the present disclosure may convert an input floating point number into a fixed point number, thereby implementing perception-free conversion of floating point data into fixed point data and improving user experience. Besides, no additional resources are needed for data fixed point conversion processing, thereby saving computing resources.

First, the data extraction module 210 extracts sign bits, exponent bits, and floating point mantissa bits in each first floating point number a[i] and each second floating point number b[i] in parallel. The sign bits are recorded as a[i][31] and b[i][31] respectively, the exponent bits are recorded as a[i][30:23] and b[i][30:23] respectively, and the floating point mantissa bits are recorded as a[i][22:0] and b[i][22:0] respectively.

Then, a second preset number of most significant mantissa bits are extracted from most significant bits of floating point mantissa bits.

In some embodiments, the first fixed point number and the second fixed point number obtained through conversion may be fixed point data of 16 bits. Accordingly, the second preset number may be 14 bits, that is, data of 14 most significant bits may be extracted from a[i][22:0] and b[i][22:0] respectively, and obtained most significant mantissa bits are a[i][22:9] and b[i][22:9] respectively.

In some embodiments, a fixed point number corresponding to each floating point number may be obtained according to most significant mantissa bits and a sign bit based on the following formula:

a.us[i]={1′b0,1′b1,a[i][22:9]}, i∈[0,k−1]

b.us[i]={1′b0,1′b1,b[i][22:9]}, i∈[0,k−1]

where a.us[i] and b.us[i] respectively represent a first fixed point number and a second fixed point number corresponding to the first floating point number a[i] and the second floating point number b[i] and in data of two bits supplemented before a[i][22:9] and b[i][22:9], 1′b0^{1′b0} is a sign bit and 1′b1^{1′b1} is used to supplement an integer that is before a decimal point and that is omitted during storage of floating point data.

A first exponent a.e[i] and a second exponent b.e[i] respectively corresponding to the first fixed point number a.us[i] and the second fixed point number b.us[i] may be obtained based on the following formula:

a.e[i]=a[i][30:23], i∈[0,k−1]

b.e[i]=b[i][30:23], i∈[0,k−1]

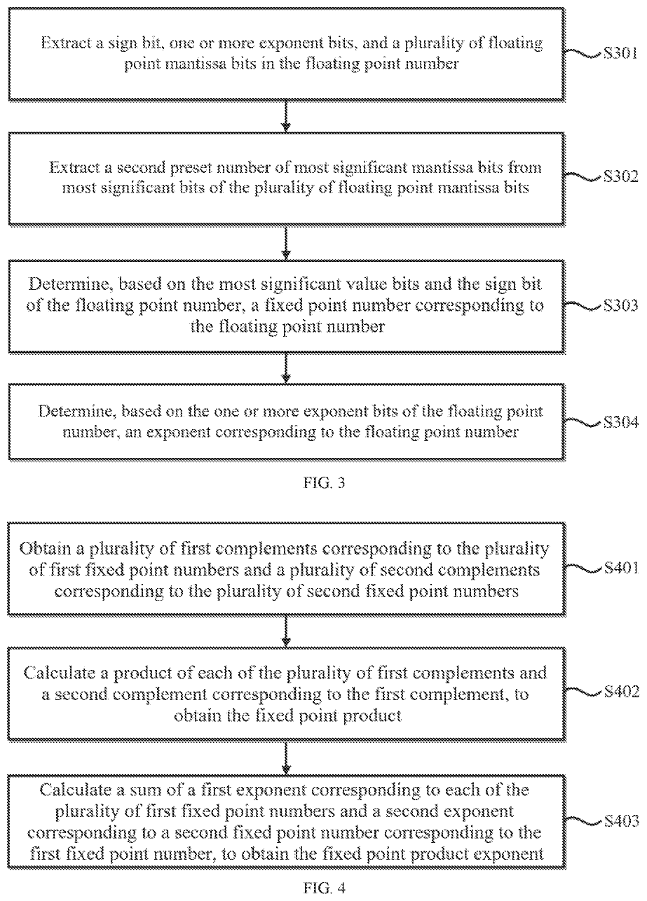

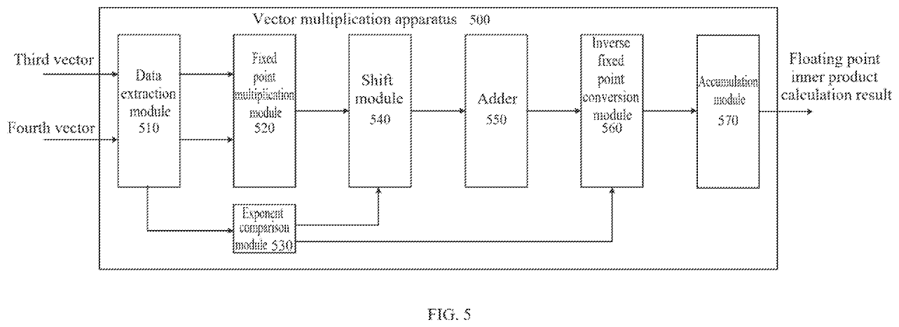

In some embodiments, as shown in FIG. 4, the obtaining a fixed point product of each of the plurality of first fixed point numbers and a second fixed point number corresponding to the first fixed point number, and a corresponding fixed point product exponent may include: Step S401: Obtain a plurality of first complements corresponding to the plurality of first fixed point numbers and a plurality of second complements corresponding to the plurality of second fixed point numbers. Step S402: Calculate a product of each of the plurality of first complements and a second complement corresponding to the first complement, to obtain the fixed point product. Step S403: Calculate a sum of a first exponent corresponding to each first fixed point number of the plurality of first fixed point numbers and a second exponent corresponding to a second fixed point number corresponding to the first fixed point number, to obtain the fixed point product exponent.

Therefore, complement conversion is performed on the fixed point number for a subsequent operation, so that the sign bit also participates in the operation and there is no need to calculate the sign bit separately, thereby saving computing resources.

In some embodiments, based on sign bits a[i][31] and b[i][31] respectively corresponding to the first floating point number a[i] and the second floating point number b[i], the first complement a.s[i] and the second complement b.s[i] respectively corresponding to the first fixed point number a.us[i] and the second fixed point number b.us[i] may be obtained based on the following formula:

$$a . s [ i ] = \{ \begin{matrix}a . us [ i ] , if a [ i ] [ 31 ] == {1}^{′} b 0 \\ 1 - a . us [ i ] , if a [ i ] [ 31 ] == {1}^{′} b 1\end{matrix} , i ∈ [ 0 , k - 1 ] \\ b . s [ i ] = \{ \begin{matrix}b . us [ i ] , if b [ i ] [ 31 ] == {1}^{′} b 0 \\ 1 - b . us [ i ] , if b [ i ] [ 31 ] == {1}^{′} b 1\end{matrix} , i ∈ [ 0 , k - 1 ]$$

In this way, the data extraction module 210 may correspondingly obtain each first fixed point number a.us[i] and a complement a.s[i] thereof and each second fixed point number b.us[i] and a complement b.s[i] thereof for each first floating point number a[i] in the first vector A and each second floating point number b[i] in the second vector B. and transmit each first fixed point number a.us[i] and a complement a.s[i] thereof and each second fixed point number b.us[i] and a complement b.s[i] thereof to the fixed point multiplication module 220. Meanwhile, the data extraction module may transmit each first exponent a.e[i] and each second exponent b.e[i] to the exponent comparison module 230.

In some embodiments, the fixed point multiplication module 220 may include a fixed point multiplication submodule of k groups of fixed point data of 16 bits, and input data of the fixed point multiplication module 220 may be each first fixed point number a.us[i] and each second fixed point number b.us[i]. Besides, the fixed point multiplication module may multiply a corresponding first fixed point number and second fixed point number, to obtain a corresponding fixed point product. A sign of the fixed point product needs to be determined based on sign bits of a first floating point number and a second floating point number corresponding to the first fixed point number and the second fixed point number.

In some embodiments, the fixed point multiplication module 220 may include a fixed point multiplication submodule of k groups of fixed point data of 16 bits, and input data of the fixed point multiplication module 220 may also be the first complement a.s[i] corresponding to each first fixed point number and the second complement b.s[i] corresponding to each second fixed point number. A corresponding first complement a.s[i] and second complement b.s[i] in each pair are multiplied to obtain a fixed point product m[i]. A specific formula is as follows:

m[i]a.s[i]*b.s[i], i∈[0,k−1]

Each fixed point product m[i] is 32 bits.

Correspondingly, the exponent comparison module 230 may obtain a fixed point product exponent ab.e[i] corresponding to each fixed point product m[i]. A specific formula is as follows:

ab.e[i]=a.e[i]+b.e[i], i∈[0,k−1]

Because exponents corresponding to fixed point products are different, fixed point products first need to be unified to fall within a same value range before fixed point products are added. For example, mantissa bits of two fixed point products are both 1001, but values corresponding to exponents of the fixed point products are 2 and −2. In this case, actual values of the fixed point products are 100.1 and 0.01001 respectively (that is, the two fixed point products are shifted and aligned based on the exponent 0, so that the two fixed point products are unified to fall within a same value range), and a subsequent addition calculation result is correct.

Generally, a maximum value in each vector is first obtained and a value range of each piece of data in the vector is unified based on the maximum value before data input. As a result, data loses great precision again after being converted to fixed point data.

In some embodiments, the obtaining the fixed point inner product calculation result of the first vector and the second vector based on the fixed point product exponent corresponding to each of the plurality of fixed point products corresponding to the plurality of first fixed point numbers includes: arithmetically shifting, based on the fixed point product exponent corresponding to each of the plurality of fixed point products corresponding to the plurality of first fixed point numbers, the fixed point product; and adding a plurality of arithmetically shifted fixed point products corresponding to the plurality of first fixed point numbers, to obtain the fixed point inner product calculation result of the first vector and the second vector.

Therefore, after each fixed point product is obtained and before the fixed point inner product calculation result is calculated, each fixed point product is shifted to unify a value range of each fixed point product. This can reduce the loss of data precision and improve calculation precision compared with the method in the related technologies.

In some embodiments, each fixed point product and each fixed point product exponent may be correspondingly input into the shift module 240, so that each fixed point product may be arithmetically shifted based on a corresponding fixed point product exponent, to align fixed point products to fall within a same value range. Then, the aligned fixed point products are input into the adder 250 to obtain the fixed point inner product calculation result of the first vector and the second vector.

In some embodiments, the arithmetically shifting, based on the fixed point product exponent corresponding to each of the plurality of fixed point products corresponding to the plurality of first fixed point numbers, the fixed point product includes: determining a first fixed point product exponent in a plurality of fixed point product exponents corresponding to the plurality of first fixed point numbers; obtaining, based on each of the plurality of fixed point product exponents and the first fixed point product exponent, an arithmetic shift value corresponding to each of the plurality of fixed point products; and arithmetically shifting the fixed point product based on the arithmetic shift value corresponding to each of the plurality of fixed point products.

In some embodiments, the first fixed point product exponent may be determined in all fixed point product exponents as the reference for arithmetic shift. A shift distance corresponding to each fixed point product is determined by calculating a difference between another fixed point product exponent and the first fixed point product exponent. Therefore, the operation can be further simplified, the operation efficiency can be improved, and computing resources can be saved.

In some embodiments, the determining the first fixed point product exponent in the plurality of fixed point product exponents corresponding; to the plurality of first fixed point numbers includes: obtaining, as the first fixed point product exponent, a largest fixed point product exponent of the plurality of fixed point product exponents corresponding to the plurality of first fixed point numbers; and the obtaining; based on each of the plurality of fixed point product exponents and the first fixed point product exponent, the arithmetic shift value corresponding to each of the plurality of fixed point products includes: calculating a difference between the first fixed point product exponent and each of the plurality of fixed point product exponents as the arithmetic shift value of the fixed point product corresponding to the fixed point product exponent.

Therefore, the first fixed point product exponent, that is, the reference exponent, is determined as the maximum exponent of all exponents, so that this can avoid great precision loss of data with a large actual value and ensure calculation precision.

In some embodiments, the exponent comparison module 230 may first obtain the maximum exponent of all fixed point product exponents ab.e[i] as the first fixed point product exponent ab.e.max. A specific formula is as follows:

ab.e.max=max(ab.e[i])

Then, each arithmetic shift value sft[i] is obtained by calculating a difference between the first fixed point product exponent ab.e.max and each fixed point product exponent ab.e[i]. A specific formula is as follows:

sft[i]=ab.e.max−ab.e[i], i∈[0,k−1]

Each arithmetic shift value sfi[i] output by the exponent comparison module 230 and each fixed point product m[i] output by the fixed point multiplication module 220 are input into the shift module 240, and the shift module 240 performs arithmetical right shift processing on each fixed point product m[i] based on an arithmetic shift value sft[i] corresponding to the fixed point product m[i], to obtain a corresponding arithmetically shifted fixed point product m.s[i]. A specific formula is as follows:

m.s[i]=m[i]>>>sft[i], i∈[0,k−1]

In some embodiments, each arithmetically shifted fixed point product m.s[i] output by the shift module 240 may be input into the adder 250, and the adder 250 adds arithmetically shifted fixed point products, so as to obtain a fixed point inner product calculation result s.i of the first vector A and the second vector B. A specific formula is as follows:

s.i=sum(m.s[i]), i∈[0,k−1]

The fixed point inner product calculation result s.i is signed fixed point data of (32+j) bits, where j is determined based on the following formula:

j=ceiling(log₂k)

^{ceiling(x)}ceiling(x) is a function used to round up data. In this way, more bits are set for the fixed point inner product calculation result s.i to prevent data overflow during addition.

In some embodiments, the inverse fixed point conversion module 260 may perform processing to obtain, based on the fixed point inner product calculation result, a floating point inner product calculation result in a floating point data format corresponding to the fixed point inner product calculation result.

The adder 250 transmits the fixed point inner product calculation result s.i to the inverse fixed point conversion module 260, and the inverse fixed point conversion module 260 first converts the fixed point inner product calculation result s.i to equal data s.f in a floating point format.

At the same time, the exponent comparison apparatus 230 transmits the first fixed point product exponent ab.e.max to the inverse fixed point conversion module 260, and the inverse fixed point conversion module 260 converts the first fixed point product exponent ab.e.max into exponent data d.f in a floating point format. A specific formula is as follows:

d.f[31]=1′b0

d.f[30:23]=ab.e.max−282

d.f[22:0]=23′b0

Then, a floating point multiplier in the inverse fixed point conversion module 260 calculates a product of s.f and d.f, to obtain a floating point inner product calculation result res in a floating point data format of the first vector and the second vector. A specific formula is as follows:

res=d.f*s.f

In some embodiments, the computing apparatus can calculate an inner product of two vectors with a first predetermined length in one computing cycle, and for a third vector and a fourth vector with a same vector length larger than the first predetermined length, the method further includes: dividing the third vector and the fourth vector into a plurality of first vectors and a plurality of second vectors based on the first predetermined length, wherein the plurality of first vectors correspond to the plurality of second vectors respectively; calculating a plurality of floating point inner product calculation results of a plurality of groups of a first vector and a second vector that correspond to each other; and calculating a sum of the plurality of floating point inner product calculation results of the plurality of groups of the first vector and the second vector that correspond to each other, to obtain an inner product calculation result of the third vector and the fourth vector.

Therefore, an input vector is divided and input into the computing apparatus in different computing cycles, and results obtained in all the computing cycles are accumulated, to calculate an inner product of larger vectors.

FIG. 5 is a structural block diagram of a vector multiplication apparatus according to another embodiment of the present disclosure.

In some embodiments, a vector multiplication apparatus 500 shown in FIG. 5 may be an computing apparatus arranged on a chip, and the above computing method may be performed by the vector multiplication apparatus 500. Specifically, the vector multiplication apparatus 500 includes a data extraction module 510, a fixed point multiplication module 520, an exponent comparison module 530, a shift module 540, an adder 550, an inverse fixed point conversion module 560, and an accumulation module 570.

Operations of the module 510 to the module 560 in the vector multiplication apparatus 500 are similar to those of the module 210 to the module 260 in the vector multiplication apparatus 200. Details are not described herein again.

In some embodiments, the data extraction module 510 may sequentially extract, in each computing cycle, a first vector and a second vector of a first predetermined length from a third vector and a fourth vector input into the vector multiplication apparatus 500, obtain a floating point inner product calculation result of the first vector and the second vector in the computing cycle, and store the floating point inner product calculation result in the accumulation module 570. After obtaining each floating point inner product calculation result, the accumulation module 570 calculates a sum of all floating point inner product calculation results, so that an inner product calculation result in a floating point format of the third vector and the fourth vector may be obtained.

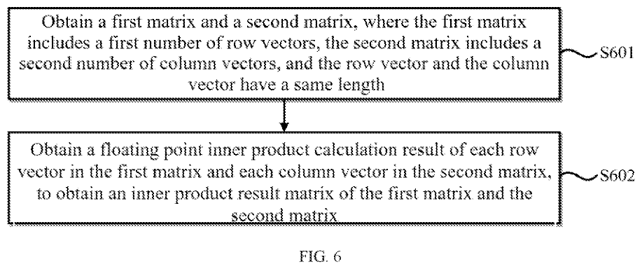

In some embodiments, a computing method performed by an computing apparatus to calculate a product of matrices is further provided, as shown in FIG. 6, including: Step S601: Obtain a first matrix and a second matrix, where the first matrix includes a first number of row vectors, the second matrix includes a second number of column vectors, and the row vector and the column vector have a same length. Step S602: Obtain a floating point inner product calculation result of each row vector in the first matrix and each column vector in the second matrix according to the above computing method for calculating an inner product of vectors, to obtain an inner product result matrix of the first matrix and the second matrix.

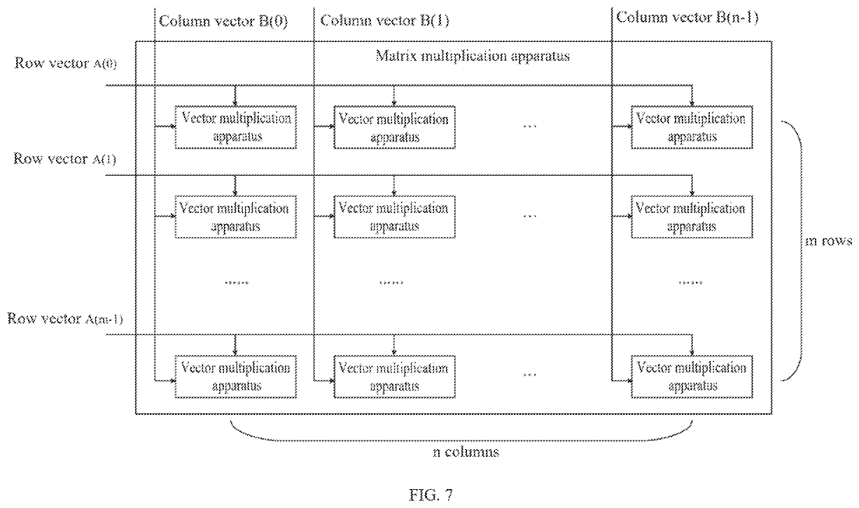

FIG. 7 is a structural block diagram of a matrix multiplication apparatus according to an embodiment of the present disclosure.

In some embodiments, a matrix multiplication apparatus shown in FIG. 7 may be an computing apparatus arranged on a chip, and the above computing method for calculating a product of matrices may be performed by the matrix multiplication apparatus.

A first matrix includes m row vectors A(0), A(1), . . . , and A(m−1), and a second matrix includes n column vectors B(0), B(1), . . . , and B(n−1). The matrix multiplication apparatus shown in FIG. 7 includes m×n vector multiplication apparatuses. Each vector multiplication apparatus may be the vector multiplication apparatus 200 shown in FIG. 2 or the vector multiplication apparatus 500 shown in FIG. 5. Each vector multiplication apparatus may calculate a vector inner product of a row vector A and a column vector B through the above computing method for calculating an inner product of vectors, and then a calculation result of each vector multiplication apparatus is obtained to obtain an inner product result matrix of the first matrix and the second matrix.

In some embodiments; as shown in FIG. 8, a computing apparatus 800 is provided, including: a first obtaining unit 810 configured to: obtain, based on a plurality of first floating point numbers of a first vector and a plurality of second floating point numbers of a second vector that are input to the computing apparatus, a plurality of first fixed point numbers in binary representation and a plurality of first exponents in binary representation that correspond to the plurality of first floating point numbers respectively, and a plurality of second fixed point numbers in binary representation and a plurality of second exponents in binary representation that correspond to the plurality of second floating point numbers respectively, wherein the plurality of first floating point numbers correspond to the plurality of second floating point numbers, and each of the plurality of first fixed point number and the plurality of second fixed point numbers comprises a sign bit and a first preset number of fixed point mantissa bits; a multiplier 820 configured to obtain a fixed point product and a fixed point product exponent corresponding to the fixed point product of each first fixed point number of the plurality of first fixed point numbers and a second fixed point number corresponding to the first fixed point number; a second obtaining unit 830 configured to obtain a fixed point inner product calculation result of the first vector and the second vector based on a fixed point product exponent corresponding to each of a plurality of fixed point products corresponding to the plurality of first fixed point numbers; and a third obtaining unit 840 configured to obtain, based on the fixed point inner product calculation result, a floating point inner product calculation result in a floating point data format corresponding to the fixed point inner product calculation result.

Operations of the unit 810 to the unit 840 of the computing apparatus 800 are similar to those of step S101 to step S104 of the above-mentioned computing method executed by the computing apparatus. Details are not described herein again.

In some embodiments, the second obtaining unit may include: a shifter configured to arithmetically shift the fixed point product based on the fixed point product exponent corresponding to each of the plurality of fixed point products corresponding to the plurality of first fixed point numbers; and an adder configured to add a plurality of arithmetically shifted fixed point products corresponding to the plurality of first fixed point numbers, to obtain the fixed point inner product calculation result of the first vector and the second vector.

According to some embodiments, the shifter may include: a determining module configured to determine a first fixed point product exponent in a plurality of fixed point product exponents corresponding to the plurality of first fixed point numbers; an obtaining module configured to obtain, based on each of the plurality of fixed point product exponents and the first fixed point product exponent, an arithmetic shift value corresponding to each of the plurality of fixed point products; and a shift module configured to arithmetically shift the fixed point product based on the arithmetic shift value corresponding to each of the plurality of fixed point products.

In some embodiments, the determining module may be configured to: obtain, as the first fixed point product exponent, the largest fixed point product exponent of the plurality of fixed point product exponents corresponding to the plurality of first fixed point numbers; and the obtaining module may be configured to: calculate a difference between the first fixed point product exponent and each of the plurality of fixed point product exponents as a corresponding arithmetic shift value of a fixed point product corresponding to the fixed point product exponent.

In some embodiments, the first obtaining unit may be configured to: for each of the plurality of first floating point numbers and the plurality of second floating point numbers, perform operations of the following subunits: a first extraction subunit configured to extract a sign bit, one or more exponent bits, and a plurality of floating point mantissa bits in the floating point number, wherein the floating point number is in binary representation; a second extraction subunit configured to extract a second preset number of most significant mantissa bits from most significant bits of the plurality of floating point mantissa bits; a first determining subunit configured to determine, based on the most significant mantissa bits, a fixed point number corresponding to the floating point number; and a second determining subunit configured to determine, based on the one or more exponent bits of the floating point number, an exponent corresponding to the floating point number.

According to some embodiments, the multiplier may include: an obtaining subunit configured to: based on sign bits of the plurality of first floating point numbers corresponding to the plurality of first fixed point numbers and sign bits of the plurality of second floating point numbers corresponding to the plurality of second fixed point numbers, obtain a plurality of first complements corresponding to the plurality of first fixed point numbers and a plurality of second complements corresponding to the plurality of second fixed point numbers; a first calculation subunit configured to calculate a product of each of the plurality of first complements and a second complement corresponding to the first complement, to obtain the fixed point product; and a second calculation subunit configured to calculate a sum of a first exponent corresponding to each of the plurality of first fixed point numbers and a second exponent corresponding to a second fixed point number corresponding to the first fixed point number, to obtain the fixed point product exponent.

In some embodiments, the computing apparatus can calculate an inner product of two vectors with a first predetermined length in one computing cycle, and for a third vector and a fourth vector with a same vector length larger than the first predetermined length, the computing apparatus may further include: a division unit configured to divide the third vector and the fourth vector into a plurality of first vectors and a plurality of second vectors based on the first predetermined length, where the plurality of first vectors and the plurality of second vectors are in a one-to-one correspondence; a first calculation unit configured to calculate floating point inner product calculation results of a plurality of groups of first vectors and second vectors that correspond to each other; and a second calculation unit configured to calculate a sum of the floating point inner product calculation results of the plurality of groups of first vectors and second vectors that correspond to each other, to obtain an inner product calculation result of the third vector and the fourth vector.

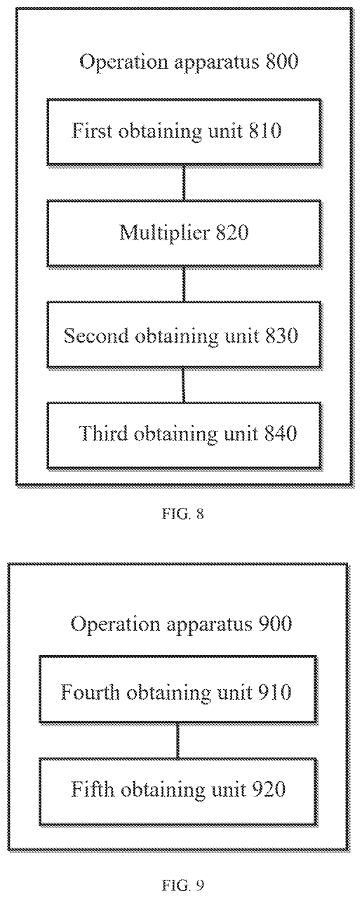

According to some embodiments, as shown in FIG. 9, a computing apparatus 900 is further provided, including: a fourth obtaining unit 910 configured to obtain a first matrix and a second matrix, where the first matrix includes a first number of row vectors, the second matrix includes a second number of column vectors, and the row vector and the column vector have a same length; and a fifth obtaining unit 920 configured to obtain an inner product result of each row vector in the first matrix and each column vector in the second matrix according to the above computing method executed by the computing apparatus to calculate an inner product of vectors, to obtain an inner product result matrix of the first matrix and the second matrix.

Operations of the unit 910 and the unit 920 of the computing apparatus 900 are similar to those of step S601 and step S602 of the above-mentioned computing method executed by the computing apparatus to calculate a product of matrices. Details are not described herein again.

In some embodiments, a chip is provided, including at least one of the following apparatuses: the above computing apparatus for calculating an inner product of vectors and the above computing apparatus for calculating an inner product of matrices.

According to some embodiments, an electronic device is provided, including the above chip.

According to some embodiments, an electronic device is provided, including: at least one processor; and a memory communicatively connected to the at least one processor, where the memory stores instructions executable by the at least one processor, and when executed by the at least one processor, the instructions cause the at least one processor to perform the above computing method for calculating an inner product of vectors or the above computing method for calculating an inner product of matrices.

According to some embodiments, a non-transitory computer-readable storage medium storing computer instructions is provided, where the computer instructions are used to cause a computer to perform the above computing method for calculating an inner product of vectors or the above computing method for calculating an inner product of matrices.

According to some embodiments, a computer program product is provided, including a computer program, where when the computer program is executed by a processor, the above computing method for calculating an inner product of vectors or the above computing method for calculating an inner product of matrices is implemented.

According to the embodiments of the present disclosure, an electronic device, a readable storage medium, and a computer program product are further provided.

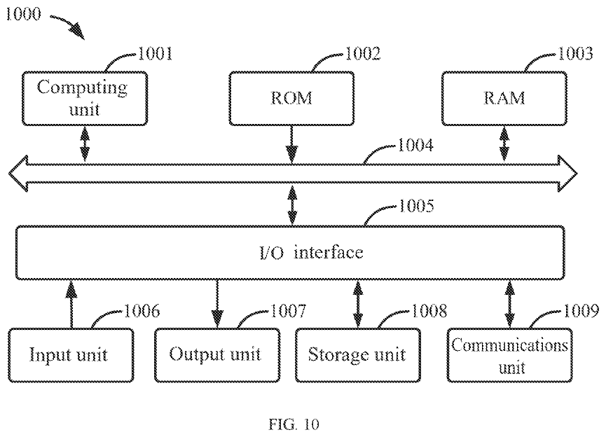

Referring to FIG. 10, a structural block diagram of an electronic device 1000 that may serve as a server or a client of the present disclosure is now described, which is an example of a hardware device that may be applied to various aspects of the present disclosure. The electronic device is intended to represent various forms of digital electronic computer devices, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown herein, their connections and relationships, and their functions are merely examples, and are not intended to limit the implementation of the present disclosure described and/or required herein.

As shown in FIG. 10, the electronic device 1000 includes a computing unit 1001, which may perform various appropriate actions and processing according to a computer program stored in a read-only memory (ROM) 1002 or a computer program loaded from a storage unit 1008 to a random access memory (RAM) 1003. The RAM 1003 may further store various programs and data required for the operation of the electronic device 1000. The computing unit 1001, the ROM 1002, and the RAM 1003 are connected to each other through a bus 1004. An input/output (I/O) interface 1005 is also connected to the bus 1004.

A plurality of components in the electronic device 1000 are connected to the I/O interface 1005, including: an input unit 1006, an output unit 1007, the storage unit 1008, and a communications unit 1009. The input unit 1006 may be any type of device capable of entering information to the electronic device 1000. The input unit 1006 can receive entered digit or character information, and generate a key signal input related to user settings and/or function control of the electronic device, and may include, but is not limited to, a mouse, a keyboard, a touchscreen, a trackpad, a trackball, a joystick, a microphone, and/or a remote controller. The output unit 1007 may be any type of device capable of presenting information, and may include, but is not limited to, a display, a speaker, a video/audio output terminal, a vibrator, and/or a printer. The storage unit 1008 may include, but is not limited to, a magnetic disk and an optical disc. The communications unit 1009 allows the electronic device 1000 to exchange information/data with other devices via a computer network such as the Internet and/or various telecommunications networks, and may include, but is not limited to, a modem, a network interface card, an infrared communications device, and a wireless communications transceiver and/or a chipset, for example, a Bluetooth™ device, an 802.11 device, a Wi-Fi device, a WiMax device, a cellular communications device, and/or the like.

The computing unit 1001 may be various general-purpose and/or special-purpose processing components with processing and computing capabilities. Some examples of the computing unit 1001 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 1001 performs the various methods and processing described above, for example, the above computing method for calculating an inner product of vectors or the above computing method for calculating an inner product of matrices. For example, in some embodiments, the above computing method for calculating an inner product of vectors or the above computing method for calculating an inner product of matrices may be implemented as a computer software program, which is tangibly contained in a machine-readable medium, such as the storage unit 1008. In some embodiments, a part or all of the computer programs may be loaded and/or installed onto the electronic device 1000 via the ROM 1002 and/or the communications unit 1009. When the computer program is loaded onto the RAM 1003 and executed by the computing unit 1001, one or more steps of the above computing method for calculating an inner product of vectors or the above computing method for calculating an inner product of matrices described above can be performed. Alternatively, in other embodiments, the computing unit 1001 may be configured, by any other suitable means (for example, by means of firmware), to perform the above computing method for calculating an inner product of vectors or the above computing method for calculating an inner product of matrices.

Various implementations of the systems and technologies described herein above can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logical device (CPLD), computer hardware, firmware, software, and/or a combination thereof. These various implementations may include: The systems and technologies are implemented in one or more computer programs, where the one or more computer programs may be executed and/or interpreted on a programmable system including at least one programmable processor. The programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

Program codes used to implement the method of the present disclosure can be written in any combination of one or more programming languages. These program codes may be provided for a processor or a controller of a general-purpose computer, a special-purpose computer, or other programmable data processing apparatuses, such that when the program codes are executed by the processor or the controller, the functions/operations specified in the flowcharts and/or block diagrams are implemented. The program codes may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus; or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein can be implemented on a computer which has: a display apparatus (for example, a cathode-ray tube (CRT) or a liquid crystal display (LCD) monitor) configured to display information to the user; and a keyboard and a pointing apparatus (for example, a mouse or a trackball) through which the user can provide an input to the computer. Other types of apparatuses can also be used to provide interaction with the user; for example, feedback provided to the user can be any form of sensory feedback (for example, visual feedback, auditory feedback, or tactile feedback), and an input from the user can be received in any form (including an acoustic input, a voice input, or a tactile input).

The systems and technologies described herein can be implemented in a computing system (for example, as a data server) including a backend component, or a computing system (for example, an application server) including a middleware component, or a computing system (for example, a user computer with a graphical user interface or a web browser through which the user can interact with the implementation of the systems and technologies described herein) including a frontend component, or a computing system including any combination of the backend component, the middleware component, or the frontend component. The components of the system can be connected to each other through digital data communication (for example, a communications network) in any form or medium. Examples of the communications network include: a local area network (LAN), a wide area network (WAN), and the Internet.

A computer system may include a client and a server. The client and the server are generally far away from each other and usually interact through a communications network. A relationship between the client and the server is generated by computer programs running on respective computers and having a client-server relationship with each other. The server may be a cloud server, a server in a distributed system, or a server combined with a blockchain.

It should be understood that steps may be reordered, added, or deleted based on the various forms of procedures shown above. For example, the steps recorded in the present disclosure may be performed in parallel, in order, or in a different order, provided that the desired result of the technical solutions disclosed in the present disclosure can be achieved, which is not limited herein.

Although the embodiments or examples of the present disclosure have been described with reference to the accompanying drawings, it should be appreciated that the method, system, and device described above are merely example embodiments or examples, and the scope of the present invention is not limited by the embodiments or examples, but defined only by the granted claims and the equivalent scope thereof. Various elements in the embodiments or examples may be omitted or substituted by equivalent elements thereof. Moreover, the steps may be performed in an order different from that described in the present disclosure. Further, various elements in the embodiments or examples may be combined in various ways. It is important that, as the technology evolves, many elements described herein may be replaced with equivalent elements that appear after the present disclosure.

What is claimed is:

1. A computing method executed by a computing apparatus, comprising:
obtaining, based on a plurality of first floating point numbers of a first vector and a plurality of second floating point numbers of a second vector that are input to the computing apparatus, a plurality of first fixed point numbers in binary representation and a plurality of first exponents in binary representation that correspond to the plurality of first floating point numbers respectively, and a plurality of second fixed point numbers in binary representation and a plurality of second exponents in binary representation that correspond to the plurality of second floating point numbers respectively, wherein the plurality of first floating point numbers correspond to the plurality of second floating point numbers, and each of the plurality of first fixed point number and the plurality of second fixed point numbers comprises a sign bit and a first preset number of fixed point mantissa bits;
obtaining a fixed point product and a fixed point product exponent corresponding to the fixed point product of each first fixed point number of the plurality of first fixed point numbers and a second fixed point number corresponding to the first fixed point number;
obtaining a fixed point inner product calculation result of the first vector and the second vector based on the fixed point product exponent corresponding to each of a plurality of fixed point products corresponding to the plurality of first fixed point numbers; and
obtaining, based on the fixed point inner product calculation result, a floating point inner product calculation result in a floating point data format corresponding to the fixed point inner product calculation result.

2. The method according to claim 1, wherein the obtaining the fixed point inner product calculation result of the first vector and the second vector based on the fixed point product exponent corresponding to each of the plurality of fixed point products corresponding to the plurality of first fixed point numbers comprises:
arithmetically shifting, based on the fixed point product exponent corresponding to each of the plurality of fixed point products corresponding to the plurality of first fixed point numbers, the fixed point product; and
adding a plurality of arithmetically shifted fixed point products corresponding to the plurality of first fixed point numbers, to obtain the fixed point inner product calculation result of the first vector and the second vector.

3. The method according to claim 2, wherein the arithmetically shifting, based on the fixed point product exponent corresponding to each of the plurality of fixed point products corresponding to the plurality of first fixed point numbers, the fixed point product comprises:
determining a first fixed point product exponent in a plurality of fixed point product exponents corresponding to the plurality of first fixed point numbers;
obtaining, based on each of the plurality of fixed point product exponents and the first fixed point product exponent, an arithmetic shill value corresponding to each of the plurality of fixed point products; and
arithmetically shifting the fixed point product based on the arithmetic shift value corresponding to each of the plurality of fixed point products.

4. The method according to claim 3, wherein the determining the first fixed point product exponent in the plurality of fixed point product exponents corresponding to the plurality of first fixed point numbers comprises:
obtaining, as the first fixed point product exponent, a largest fixed point product exponent of the plurality of fixed point product exponents corresponding to the plurality of first fixed point numbers; and
wherein the obtaining, based on each of the plurality of fixed point product exponents and the first fixed point product exponent, the arithmetic shift value corresponding to each of the plurality of fixed point products comprises:
calculating a difference between the first fixed point product exponent and each of the plurality of fixed point product exponents as the arithmetic shift value of the fixed point product corresponding to the fixed point product exponent.

5. The method according to claim 1, wherein the obtaining the plurality of first fixed point numbers in binary representation and the plurality of first exponents in binary representation that correspond to the plurality of first floating point numbers respectively, and the plurality of second fixed point numbers in binary representation and the plurality of second exponents in binary representation that correspond to the plurality of second floating point numbers respectively comprises:
for each floating point number of the plurality of first floating point numbers and the plurality of second floating point numbers, performing the following operations:
extracting a sign bit, one or more exponent bits, and a plurality of floating point mantissa bits in the floating point number, wherein the floating point number is in binary representation;
extracting a second preset number of most significant mantissa bits from most significant bits of the plurality of floating point mantissa bits;
determining, based on the most significant mantissa bits, a fixed point number corresponding to the floating point number; and
determining, based on the one or more exponent bits of the floating point number, an exponent corresponding to the floating point number.

6. The method according to claim 5, wherein the obtaining the fixed point product and the fixed point product exponent corresponding to the fixed point product of each first fixed point number of the plurality of first fixed point numbers and the second fixed point number corresponding to the first fixed point number comprises:
obtaining, based on the sign bit of each of the plurality of first floating point numbers corresponding to the plurality of first fixed point numbers and the sign bit of each of the plurality of second floating point numbers corresponding to the plurality of second fixed point numbers, a plurality of first complements corresponding to the plurality of first fixed point numbers and a plurality of second complements corresponding to the plurality of second fixed point numbers;
calculating a product of each first complement of the plurality of first complements and a second complement corresponding to the first complement, to obtain the fixed point product; and
calculating a sum of a first exponent corresponding to each first fixed point number of the plurality of first fixed point numbers and a second exponent corresponding to a second fixed point number corresponding to the first fixed point number, to obtain the fixed point product exponent.

7. The method according to claim 1, wherein the computing apparatus calculates an inner product of two vectors with a first predetermined length in one computing cycle, and for a third vector and a fourth vector with a same vector length larger than the first predetermined length, the method further comprises:
dividing the third vector and the fourth vector into a plurality of first vectors and a plurality of second vectors based on the first predetermined length, wherein the plurality of first vectors correspond to the plurality of second vectors respectively;
calculating a plurality of floating point inner product calculation results of a plurality of groups of a first vector and a second vector that correspond to each other; and
calculating a sum of the plurality of floating point inner product calculation results of the plurality of groups of the first vector and the second vector that correspond to each other, to obtain an inner product calculation result of the third vector and the fourth vector.

8. The method according to claim 1, further comprising:
obtaining a first matrix and a second matrix, wherein the first matrix comprises a first number of row vectors, the second matrix comprises a second number of column vectors, and the row vector and the column vector have a same length; and
obtaining a floating point inner product calculation result of each row vector in the first matrix and each column vector in the second matrix, to obtain an inner product result matrix of the first matrix and the second matrix.

9. An electronic device, comprising:
one or more processors; and
a memory storing one or more programs configured to be executed by the one or more processors, the one or more programs comprising instructions for performing operations comprising:
obtaining, based on a plurality of first floating point numbers of a first vector and a plurality of second floating point numbers of a second vector that are input to the electronic device, a plurality of first fixed point numbers in binary representation and a plurality of first exponents in binary representation that correspond to the plurality of first floating point numbers respectively, and a plurality of second fixed point numbers in binary representation and a plurality of second exponents in binary representation that correspond to the plurality of second floating point numbers respectively, wherein the plurality of first floating point numbers correspond to the plurality of second floating point numbers, and each of the plurality of first fixed point number and the plurality of second fixed point numbers comprises a sign bit and a first preset number of fixed point mantissa bits;
obtaining a fixed point product and a fixed point product exponent corresponding to the fixed point product of each first fixed point number of the plurality of first fixed point numbers and a second fixed point number corresponding to the first fixed point number;
obtaining a fixed point inner product calculation result of the first vector and the second vector based on the fixed point product exponent corresponding to each of a plurality of fixed point products corresponding to the plurality of first fixed point numbers; and
obtaining, based on the fixed point inner product calculation result, a floating point inner product calculation result in a floating point data format corresponding to the fixed point inner product calculation result.

10. The electronic device according to claim 9, wherein the obtaining the fixed point inner product calculation result of the first vector and the second vector based on the fixed point product exponent corresponding to each of the plurality of fixed point products corresponding to the plurality of first fixed point numbers comprises:
arithmetically shifting, based on the fixed point product exponent corresponding to each of the plurality of fixed point products corresponding to the plurality of first fixed point numbers, the fixed point product; and
adding a plurality of arithmetically shifted fixed point products corresponding to the plurality of first fixed point numbers, to obtain the fixed point inner product calculation result of the first vector and the second vector.

11. The electronic device according to claim 10, wherein the arithmetically shifting, based on the fixed point product exponent corresponding to each of the plurality of fixed point products corresponding to the plurality of first fixed point numbers, the fixed point product comprises:
determining a first fixed point product exponent in a plurality of fixed point product exponents corresponding to the plurality of first fixed point numbers;
obtaining, based on each of the plurality of fixed point product exponents and the first fixed point product exponent, an arithmetic shift value corresponding to each of the plurality of fixed point products; and
arithmetically shifting the fixed point product based on the arithmetic shift value corresponding to each of the plurality of fixed point products.

12. The electronic device according to claim 11, wherein the determining the first fixed point product exponent in the plurality of fixed point product exponents corresponding to the plurality of first fixed point numbers comprises:
obtaining, as the first fixed point product exponent, a largest fixed point product exponent of the plurality of fixed point product exponents corresponding to the plurality of first fixed point numbers; and
wherein the obtaining, based on each of the plurality of fixed point product exponents and the first fixed point product exponent, the arithmetic shift value corresponding to each of the plurality of fixed point products comprises:
calculating a difference between the first fixed point product exponent and each of the plurality of fixed point product exponents as the arithmetic shift value of the fixed point product corresponding to the fixed point product exponent.

13. The electronic device according to claim 9, wherein the obtaining the plurality of first fixed point numbers in binary representation and the plurality of first exponents in binary representation that correspond to the plurality of first floating point numbers respectively, and the plurality of second fixed point numbers in binary representation and the plurality of second exponents in binary representation that correspond to the plurality of second floating point numbers respectively comprises:
for each floating point number of the plurality of first floating point numbers and the plurality of second floating point numbers, performing the following operations:
extracting a sign bit, one or more exponent bits, and a plurality of floating point mantissa bits in the floating point number, wherein the floating point number is in binary representation;
extracting a second preset number of most significant mantissa bits from most significant bits of the plurality of floating point mantissa bits;
determining, based on the most significant mantissa bits, a fixed point number corresponding to the floating point number; and
determining, based on the one or more exponent bits of the floating point number, an exponent corresponding to the floating point number.

14. The electronic device according to claim 13, wherein the obtaining the fixed point product and the fixed point product exponent corresponding to the fixed point product of each first fixed point number of the plurality of first fixed point numbers and the second fixed point number corresponding to the first fixed point number comprises:
obtaining, based on the sign bit of each of the plurality of first floating point numbers corresponding to the plurality of first fixed point numbers and the sign bit of each of the plurality of second floating point numbers corresponding to the plurality of second fixed point numbers, a plurality of first complements corresponding to the plurality of first fixed point numbers and a plurality of second complements corresponding to the plurality of second fixed point numbers;
calculating a product of each first complement of the plurality of first complements and a second complement corresponding to the first complement, to obtain the fixed point product; and
calculating a sum of a first exponent corresponding to each first fixed point number of the plurality of first fixed point numbers and a second exponent corresponding to a second fixed point number corresponding to the first fixed point number, to obtain the fixed point product exponent.

15. The electronic device according to claim 9, wherein the electronic device calculates an inner product of two vectors with a first predetermined length in one computing cycle, and for a third vector and a fourth vector with a same vector length larger than the first predetermined length, and wherein the operations further comprises:
dividing the third vector and the fourth vector into a plurality of first vectors and a plurality of second vectors based on the first predetermined length, wherein the plurality of first vectors correspond to the plurality of second vectors respectively;
calculating a plurality of floating point inner product calculation results of a plurality of groups of a first vector and a second vector that correspond to each other; and
calculating a sum of the plurality of floating point inner product calculation results of the plurality of groups of the first vector and the second vector that correspond to each other, to obtain an inner product calculation result of the third vector and the fourth vector.

16. The electronic device according to claim 9, wherein the operations further comprises:
obtaining a first matrix and a second matrix, wherein the first matrix comprises a first number of row vectors, the second matrix comprises a second number of column vectors, and the row vector and the column vector have a same length; and
obtaining a floating point inner product calculation result of each row vector in the first matrix and each column vector in the second matrix, to obtain an inner product result matrix of the first matrix and the second matrix.

17. A non-transitory computer-readable storage medium storing one or more programs comprising instructions that, when executed by one or more processors of a computing device, cause the computing device to perform operations comprising:
obtaining, based on a plurality of first floating point numbers of a first vector and a plurality of second floating point numbers of a second vector that are input to the computing device, a plurality of first fixed point numbers in binary representation and a plurality of first exponents in binary representation that correspond to the plurality of first floating point numbers respectively, and a plurality of second fixed point numbers in binary representation and a plurality of second exponents in binary representation that correspond to the plurality of second floating point numbers respectively, wherein the plurality of first floating point numbers correspond to the plurality of second floating point numbers, and each of the plurality of first fixed point number and the plurality of second fixed point numbers comprises a sign bit and a first preset number of fixed point mantissa bits;
obtaining a fixed point product and a fixed point product exponent corresponding to the fixed point product of each first fixed point number of the plurality of first fixed point numbers and a second fixed point number corresponding to the first fixed point number;
obtaining a fixed point inner product calculation result of the first vector and the second vector based on the fixed point product exponent corresponding to each of a plurality of fixed point products corresponding to the plurality of first fixed point numbers; and
obtaining, based on the fixed point inner product calculation result, a floating point inner product calculation result in a floating point data format corresponding to the fixed point inner product calculation result.

18. The computer-readable storage medium of claim 17, wherein the obtaining the fixed point inner product calculation result of the first vector and the second vector based on the fixed point product exponent corresponding to each of the plurality of fixed point products corresponding to the plurality of first fixed point numbers comprises:
arithmetically shifting, based on the fixed point product exponent corresponding to each of the plurality of fixed point products corresponding to the plurality of first fixed point numbers, the fixed point product; and
adding a plurality of arithmetically shifted fixed point products corresponding to the plurality of first fixed point numbers, to obtain the fixed point inner product calculation result of the first vector and the second vector.

19. The computer-readable storage medium of claim 18, wherein the arithmetically shifting, based on the fixed point product exponent corresponding to each of the plurality of fixed point products corresponding to the plurality of first fixed point numbers, the fixed point product comprises:
determining a first fixed point product exponent in a plurality of fixed point product exponents corresponding to the plurality of first fixed point numbers;
obtaining, based on each of the plurality of fixed point product exponents and the first fixed point product exponent, an arithmetic shift value corresponding to each of the plurality of fixed point products; and
arithmetically shifting the fixed point product based on the arithmetic shift value corresponding to each of the plurality of fixed point products.

20. The computer-readable storage medium of claim 19, wherein the determining the first fixed point product exponent in the plurality of fixed point product exponents corresponding to the plurality of first fixed point numbers comprises:
obtaining, as the first fixed point product exponent, a largest fixed point product exponent of the plurality of fixed point product exponents corresponding to the plurality of first fixed point numbers; and
wherein the obtaining, based on each of the plurality of fixed point product exponents and the first fixed point product exponent, the arithmetic shift value corresponding to each of the plurality of fixed point products comprises:
calculating a difference between the first fixed point product exponent and each of the plurality of fixed point product exponents as the arithmetic shift value of the fixed point product corresponding to the fixed point product exponent.
